(19) United States
(12) Patent Application Publication
(10) Pub. No.: US 2016/0049733 A1
(43) Pub. Date: Feb. 18, 2016

(54) Method and Apparatus for Orthogonal-Mode Junction Coupling

(71) Applicant: COMMONWEALTH SCIENTIFIC AND INDUSTRIAL RESEARCH ORGANISATION, Campbell, Autralian Capital Territory (AU)

(72) Inventor: Alexander Ray Dunning, Ashfield (AU)

(73) Assignee: Commonwealth Scientific and Industrial Research Organisation, Campbell (AU)

(21) Appl. No.: 14/782,315

(22) PCT Filed: Apr. 4, 2014
(86) PCT No.: PCT/AU2014/000366

§ 371 Date: Oct. 2, 2015

(30) Foreign Application Priority Data
Apr. 5, 2013 (AU) 2013901179

(51) Int. Cl. H01Q 13/06; H01Q 15/24; H01P 1/161

(52) U.S. Cl. CPC H01Q 13/06; H01P 1/161; H01Q 15/242

(57) ABSTRACT

An orthogonal mode transducer including: an elongated waveguide conduit for projecting orthogonal polarisation transmissions, the conduit having a proximal emission source end and a distal mouth end having an aperture for signal transmission; and the elongated conduit including a first and a second pairs of diametrically opposed axial ridges, with the first and second pairs being substantially orthogonal to one another, and the first pair of diametrically opposed axial ridges having an asymmetric narrowing of the gap between the ridges towards the proximal emission source relative to the second pair of diametrically opposed axial ridges. The axial ridge increases in circumferential thickness towards the distal end of the conduit. The asymmetric narrowing is provisioned substantially at the proximal emission source end only with the gap between the first pair and the second pair of ridges being substantially the same at the distal mouth end of the conduit.

### FIELD OF THE INVENTION

The present invention relates to the field of orthogonal mode transducers (OMT) and, in particular, discloses an improved design for an OMT and associated antenna array.

### BACKGROUND

Any discussion of the background art throughout the specification should in no way be considered as an admission that such art is widely known or forms part of common general knowledge in the field.

An Orthogonal mode transducer (OMT) is normally used to separate or combine two orthogonal polarisation electromagnetic emissions in an input/output waveguide. One form of known OMT is the quad ridged OMT which is utilised to achieve polarisation separation. Examples of such arrangements can be found in:

“Broadband offset quad-ridged waveguide orthomode transducer” D.I.L. de Villiers, P. Meyer and K. D. Palmer, ELECTRONICS LETTERS 1 Jan. 2009 Vol. 45 No. 1.

“Double Ridged Orthogonal Mode Transducer for the 16-26 GHz Microwave Band”, Alex Dunning, Proc. of the Workshop on the Applications of Radio Science, Feb. 20-22, 2002.

“Wide-Band Orthomode Transducers”, Stephen J. Skinner and Graeme L. James, IEEE TRANSACTIONS ON MICROWAVE THEORY AND TECHNIQUES, VOL. 39, NO. 2, FEBRUARY 1991.

U.S. Pat. No. 8,248,321 entitled “Broadband/multi-band horn antenna with compact integrated feed”.

US Patent Publication 20020163401 entitled: “Wideband coaxial orthogonal-mode junction coupler”.

US Patent Publication 20020163401 entitled “Quad-ridged feed horn with two coplanar probes”.

U.S. Pat. No. 6,624,792 entitled: “Antenna feed system with closely coupled amplifier”.

Existing quad ridged designs suffer from a number of problems including: limited bandwidth as most OMT designs have bandwidths of less than 2:1; spurious mode production as most wideband OMTs produce significant levels of high order modes which have an undesirable effect on antenna radiation patterns; Polarisation cross coupling as most wideband OMTs have significant levels of coupling between the two linear polarisations.

### SUMMARY OF THE INVENTION

It is an object of the invention, in its preferred form to provide an improved orthogonal mode transducer.

In accordance with a first aspect of the present invention there is provided an orthogonal mode transducer including: an elongated waveguide conduit for projecting orthogonal polarisation transmissions, the conduit having a proximal emission source end and a distal mouth end having an aperture for signal transmission; and the elongated conduit including a first pair of diametrically opposed axial ridges, and a second pair of diametrically opposed axial ridges, with the first and second pairs being substantially orthogonal to one another, and the first pair of diametrically opposed axial ridges having an asymmetric narrowing of the gap between the ridges towards the proximal emission source relative to the second pair of diametrically opposed axial ridges.

In some embodiments, at least one of the axial ridges increases in circumferential thickness towards the distal end of the conduit. In some embodiments, the asymmetric narrowing is provisioned substantially at the proximal emission source end only with the gap between the first pair of ridges and the gap between the second pair of ridges being substantially the same at the distal mouth end of the conduit. In some embodiments, the narrowing occurs by a series of axial steps along the conduit.

In some embodiments, the proximal emission source end includes at least one conductive emission source; the conductive emission source including a capacitive device profiled to match the internal inductance of the emission source over at least a portion of the operational bandwidth of the orthogonal mode transducer. In some embodiments, the capacitive device includes a section of low impedance coaxial conductive line or a shunt capacitance between the inner and outer conductor of the coaxial conductive line.

In accordance with a further aspect of the present invention, there is provided an orthogonal mode transducer, including: an elongated waveguide conduit for projecting orthogonal polarisation transmissions, the conduit having a proximal emission source end and a distal mouth end having an aperture for signal transmission; a series of axial ridges along the internal surface of the conduit, the axial ridges increasing in circumferential thickness towards the distal end of the conduit.

The series of axial ridges are preferably arranged symmetrically around the conduit. The number of axial ridges can be four and the ridges are preferably aligned with orthogonal linear polarisation transmissions along the conduit. The radial thickness of the ridges decreases towards the distal end of the conduit. At the distal end of the conduit, the ridges arc preferably flared and the radial thickness of the ridges approaches zero.

In accordance with a further aspect of the present invention there is provided a method of suppressing spurious modes in an orthogonal mode transducer having an elongated waveguide conduit for projecting orthogonal polarisation transmissions, the conduit having a proximal emission source end and a distal mouth end having an aperture for signal transmission; the method including the steps of: forming a series of axial ridges along the internal surface of the conduit, the axial ridges increasing in circumferential thickness towards the distal end of the conduit.

In accordance with a further aspect of the present invention there is provided an orthogonal mode transducer including: an waveguide conduit for projecting orthogonal polarisation transmissions, the conduit having a proximal emission source end and a distal mouth end having an aperture for signal transmission; the proximal emission source end including at least one conductive emission source; the conductive emission source including a capacitive device profiled to match the internal inductance of the emission source over at least a portion of the operational bandwidth of the orthogonal mode transducer.

The capacitive device preferably can include a section of low impedance coaxial conductive line. In some embodiments, the capacitive device preferably can include a shunt capacitance between the inner and outer conductor of the coaxial conductive line

In accordance with a further aspect of the present invention there is provided a method of improving the operational characteristics of an orthogonal mode transducer having a waveguide conduit for projecting orthogonal polarisation transmissions, the conduit having a proximal emission source end and a distal mouth end having an aperture for signal transmission, the method including the step of: providing a capacitive device at the proximal emission source end profiled to match internal inductance of the emission source over at least a portion of the operational bandwidth of the orthogonal mode transducer.

In accordance with a further aspect of the present invention there is provided an orthogonal mode transducer including: an elongated waveguide conduit for projecting orthogonal polarisation transmissions, the conduit having a proximal emission source end and a distal mouth end having an aperture for signal transmission; the elongated conduit being narrowed towards the proximal emission source end in a radially asymmetric manner.

Preferably, the narrowing occurs via a series of axial steps along the conduit.

In some embodiments, the radial asymmetry can be provisioned substantially in the proximal emission source end only with the distal end being substantially radially symmetric.

In accordance with a further aspect of the present invention, there is provided an orthogonal mode transducer including: an elongated waveguide conduit for projecting orthogonal polarisation transmissions, the conduit having a proximal emission source end and a distal mouth end having an aperture for signal transmission; said elongated conduit including a number of mode suppression vanes between and the proximal end and a coaxial transmitter for the suppression of spurious signals emitted from the coaxial transmitter.

### BRIEF DESCRIPTION OF THE DRAWINGS

Embodiments of the invention will now be described, by way of example only, with reference to the accompanying drawings in which:

FIG. 1 illustrates a side perspective view of the preferred embodiment;

FIG. 2 illustrates a sectional view through the line A-A′ of FIG. 1;

FIG. 3 is a top plan view of the preferred embodiment of FIG. 1;

FIG. 4 is a side plan view of the preferred embodiment of FIG. 1;

FIG. 5 illustrates a top sectional view of the arrangement of FIG. 1;

FIG. 6 illustrates an end on view of the preferred embodiment;

FIG. 7 illustrates a top sectional view of the preferred embodiment;

FIG. 8 illustrates a sectional enlargement of the portion of FIG. 7;

FIG. 9 illustrates a top sectional view of the preferred embodiment;

FIG. 10 illustrates an enlargement of an area of FIG. 9;

FIG. 11 illustrates a further sectional view through the preferred embodiment;

FIG. 12 illustrates an enlargement of the portion 40 of FIG. 11;

FIG. 13 illustrates an enlargement of the orthogonal portion to the portion 40 of FIG. 11;

FIG. 14 illustrates an enlargement of the portion 42 of FIG. 11;

FIG. 15 illustrates a side sectional view of the preferred embodiment orthogonal to FIG. 7;

FIG. 16 illustrates an enlargement of the region 65 of FIG. 15; and

FIG. 17 illustrates an enlargement of the region 62 of FIG. 15.

### DETAILED DESCRIPTION

The preferred embodiments provide for an OMT that efficiently and reversibly combines two orthogonal signals incident on the OMT at two coaxial ports and combines them in such a way that each signal is transferred to one of two orthogonally polarised modes of a circular or square waveguide. Ideally the preferred embodiment provides an arrangement which offers a broadband response (>3.5:1) and the combined polarisations are substantially free from spurious modes and cross coupling.

The preferred embodiment includes a number of refinements, separately discussed, which combine to produce an improved OMT device.

### Profiling of Ridges Towards Waveguide Mouth

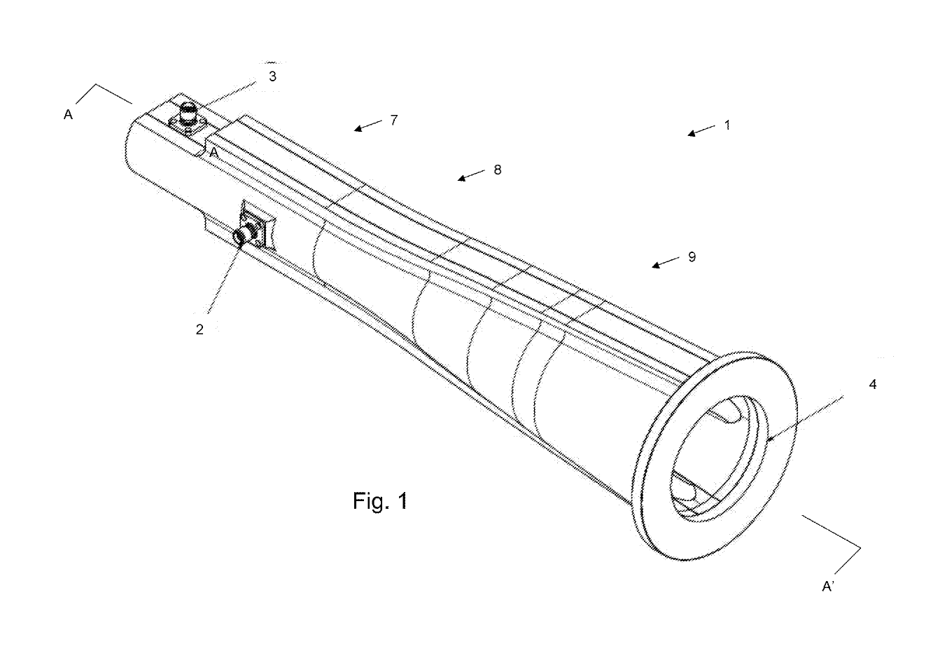

Turning initially to FIG. 1, there is illustrated a side perspective view of the OMT design 1 of the preferred embodiment. This arrangement takes two orthogonal input/output coaxial cable interconnects 2,3 and outputs an electromagnetic signal from port 4, normally to an attached horn or the like. The main body portions of the OMT can be formed from machined aluminium.

As shown in FIG. 1, the preferred embodiment provides an ortho-mode transducer (OMT) used for separation or combination of two linear polarised signals from or into a common waveguide. In the case of separation, the two linear polarised signals are incident on the device in the form of orthogonal modes in a square or circular waveguide 4 and exit the device via two coaxial waveguides 2, 3. In the case of combination, the two polarisations enter the device through the two coaxial waveguides 2,3 and exit via the square or circular waveguide 4. In the illustrated embodiment a circular waveguide is used as the common port 4.

As illustrated in FIG. 1 to FIG. 5, the OMT consists of three sections, a coaxial to double ridged transition 7 (section 1), a polarisation combining junction 8 (section 2), and a quad ridge to square or circular transition 9 (section 3).

The internal profiled surface of the OMT 1 includes four elongated ridged shaped elements 5 which assist in suppressing cross coupling and spurious modes. These ridge shaped elements include flaring 6 towards the waveguide mouth 4 to improve modal purity.

Whilst the embodiment is discussed with reference to a circular waveguide, the principles of the embodiment apply to square shaped waveguides.

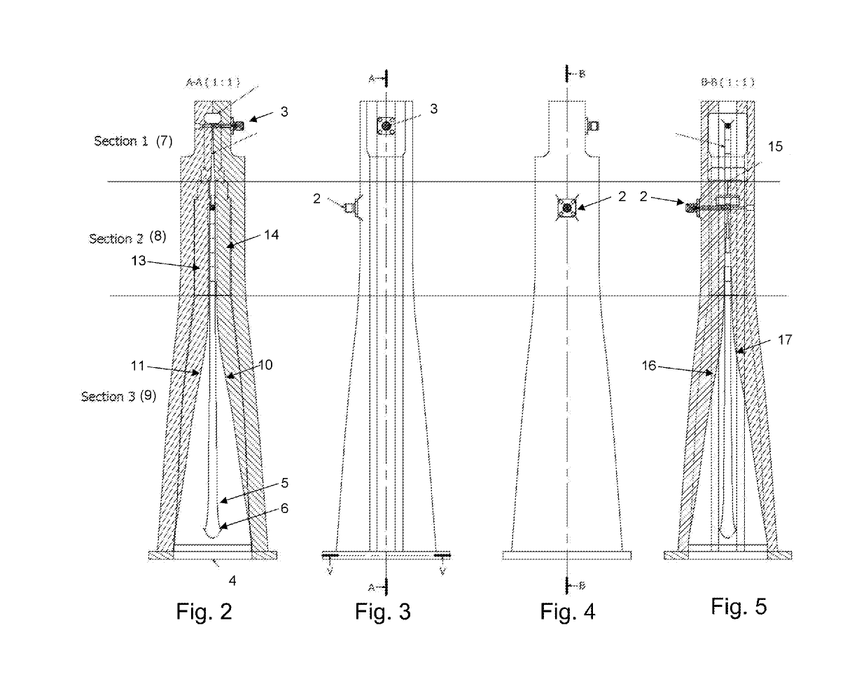

FIG. 2 is an initial sectional view taken along the line A-A′ of FIG. 1. The elongated ridge shaped element 5 include a tapering which is more pronounced 6 towards a far end thereof. Four identical ridge shaped elements are provided within the internal cavity of the OMT. Each of the ridge shape elements is substantially identical. FIG. 2 also illustrates the top element 14 and bottom element 13 which include profiled edges 10, 11.

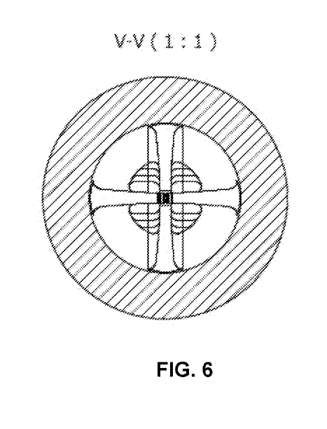

FIG. 3 illustrates a top plan view of the preferred embodiment. FIG. 4 illustrates a side plane view. FIG. 5 illustrates a top sectional view.

Returning to FIG. 2, an investigation of prior art quad ridged OMTs was found that they normally smoothly reduce the height of the ridges e.g. 10 to achieve a transition between a quad ridged waveguide and the end circular or square waveguide mouth. This has been found to produce a large amount of the TE31 mode at the waveguide aperture. This is not obvious from a simple examination of the structure. The TE31 mode is unwanted and commonly results in an asymmetrical antenna radiation pattern which is broader in one axis than the other. It has initially been surprisingly found that if the width of the ridge in the transverse direction is increased as its height is decreased, a reduced amount of the TE31 mode is produced at high frequencies.

The width of ridges 5 was therefore made to flare 6 towards the circular waveguide port of the OMT. This led to substantially reduced levels of TE31 mode production.

Mating the Coax-Ridged Waveguide Junction with a Capacitive Probe to Improve the Return Loss

In prior art devices, the junction between the coaxial ports and the double or quad ridged waveguide is commonly formed simply by terminating an outer coaxial port conductor at one ridge and extending the inner conductor of the coaxial port across the gap between two ridges and making a short circuit connection to another orthogonal ridge.

In the preferred embodiment, the junction is modified in two ways. The first consists of replacing the short circuit inner conductor/ridge connection with a corresponding capacitive connection. This can be formed by a short section of low impedance coaxial line.

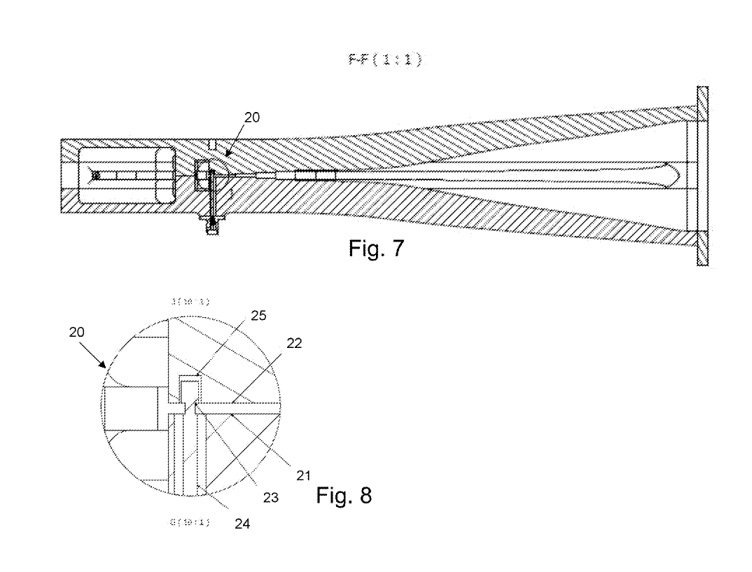

FIG. 7 illustrates a sectional view illustrating the inner conductor connection region 20. FIG. 8 illustrates an enlarged view of the inner connection region 20. The two opposing ridges are illustrated 21, 22 of the quad ridged structure. A cross section of the coaxial input line is shown 24. The coaxial input line transitions to a low impedance coaxial line 23 and an insulating support 25 is provided for the coaxial inner conductor, insulating it from the surface 22. The resulting formed series capacitance acts to cancel or match the induced inductance thereby providing a more balanced connection.

A second connection modification consists of forming a shunt capacitance between the inner conductor and the outer conductor of the coaxial line close to the termination of the outer conductor at the ridge surface. This would usually be formed by a short section of low impedance coaxial line which is achieved either by reducing the cross sectional area of the outer conductor or by increasing the cross sectional area of the inner conductor. For improved performance this may be preceded by a short section of high impedance line.

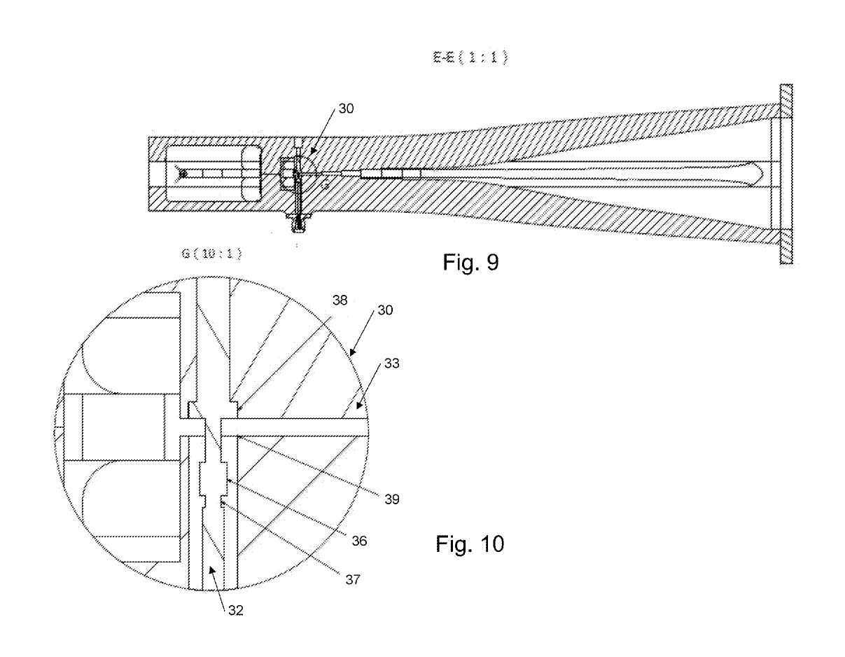

Again, FIG. 9 illustrates a sectional view illustrating an inner conductor connection region 30. FIG. 10 illustrates an enlarged view of the connection region 30. A short circuit is provided 38 between the inner coaxial line 32 and one of the ridges 33. The inner coaxial line 32 includes a low impedance capacitive section 36 of the input coax. The section 37 includes a high impedance section of the input coax.

The purpose of both of the structures of FIG. 8 and FIG. 10 is to improve the broadband return loss of the device by counteracting the inductive nature of the junction.

### Reduction in the Width of the Quad Ridged Waveguide in One Axis Behind the Polarisation Combining Junction

In some examples of an offset probe quad ridge OMI, the outer waveguide width remains equal in both axes throughout the length of the OMT. This can result in a poor high frequency termination behind the front probe and hence limits the bandwidth achievable to less than 2:1.

By stepping in the outer waveguide wall in one dimension, it was found that there was an increase in the frequency range over which the front probe sees an advantageous terminating impedance in the rear direction. That is, a terminating impedance which is close to that of an open circuit.

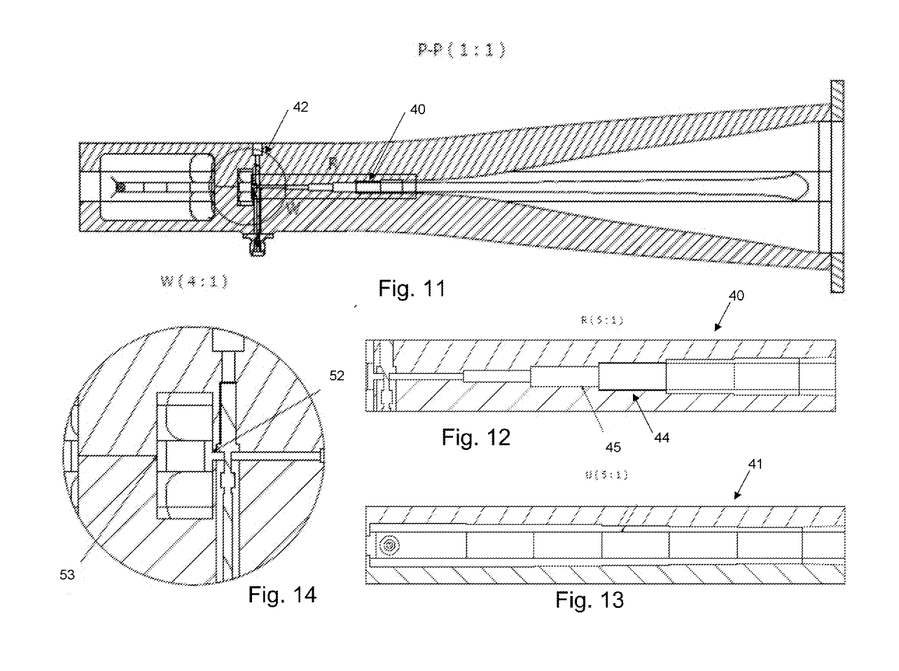

An example of the stepping is illustrated with reference to FIG. 11, FIG. 12 and FIG. 13. In FIG. 11, the region of interest being the region 40, illustrated in an enlarged view in FIG. 12. FIG. 12 illustrates an enlarged view of the section 40 of FIG. 11 and shows a series of step axial shortenings e.g. 44, 45 as the front probe is approached. The outer wall of the quad ridged waveguide steps in multiple times starting shortly after the front coax to quad ridge transition. In the orthogonal section of FIG. 13, no contraction is provided for.

There are two aspects of this structure which are significant. Firstly such steps were found to produce an acceptable terminating impedance for the front probe. Secondly, these steps were found to not interfere with the other polarisation. In the preferred embodiment, the steps are used in a quad ridged design and the steps provide for both impedance matching and an improved high frequency termination of the front probe.

The Stepped Transition from Equal Quad Ridged Waveguide to Unequal Quad Ridged Waveguide

A further important aspect of a broadband (>2:1) quad ridged OMT of the preferred embodiment is a transition from quad ridged waveguide to circular or square waveguide which is symmetric about 90 degree rotations (an equally spaced quad ridged waveguide). A quad ridged waveguide which satisfies this symmetry criterion however is less suitable than a quad ridged waveguide where two of the opposing ridges are more closely spaced than the other two ridges (unequally spaced quad ridged waveguide) for a transition to a coaxial waveguide. This is due to the possible generation of the TE21 mode. For this reason in the present embodiment a stepped transition has been adopted which transitions from an unequally spaced quad ridged waveguide to an equally spaced quad ridged waveguide followed by a smooth transition to a circular waveguide. This transition reduces the production of the TE21 mode and ensures similar mode production for both polarisations. This asymmetry is illustrated in FIG. 12 and FIG. 13 respectively.

### Further Review of the Descriptive Details

Returning to FIG. 2 to FIG. 5, section 2 (8) constitutes the polarisation combining junction. One linear polarisation enters this junction through a coaxial port 2 and the other polarisation enters via port 3 and a section of double ridged waveguide 15. As shown in FIG. 8, a junction is formed between the coaxial port 2 and a quad ridged waveguide section in which two opposing ridges 21, 22 are closely separated and the other two opposing ridges are less closely separated. The junction between these waveguides is formed in one of two ways. In the first, the coaxial waveguide enters the device through one of the closely separated ridges 21. The outer conductor of the coaxial waveguide is terminated at the surface of the ridge 39 (FIG. 10) and the inner conductor extends across the gap between the two ridges and is electrically connected to the other of the closely separated ridges 38. A short section 36 of the coaxial waveguide before it reaches the surface of the ridge is lowered in impedance to compensate for the inductive nature of the junction. This is achieved either by reducing the cross sectional area of the outer conductor or by increasing the cross sectional area of the inner conductor. In a second technique illustrated in FIG. 8 the junction is formed in a similar manner to the first however with the addition of a capacitor in series 25 between the end of the coaxial inner conductor and the opposing ridge. This capacitor may take the form of a discrete capacitor or a short section of low impedance coaxial waveguide.

Returning to FIG. 2 to FIG. 5, the quad ridge waveguide of the junction is terminated in one direction by a structure approximating an open circuit and in the other direction by a transition to symmetric quad ridge waveguide followed by a mode forming transition provided by section 3 (9).

As illustrated in FIG. 14, the structure approximating an open circuit is formed in the following manner. Immediately after the junction of the coaxial waveguide with the quad ridge waveguide, the separation of the closely spaced ridges is increased 52,

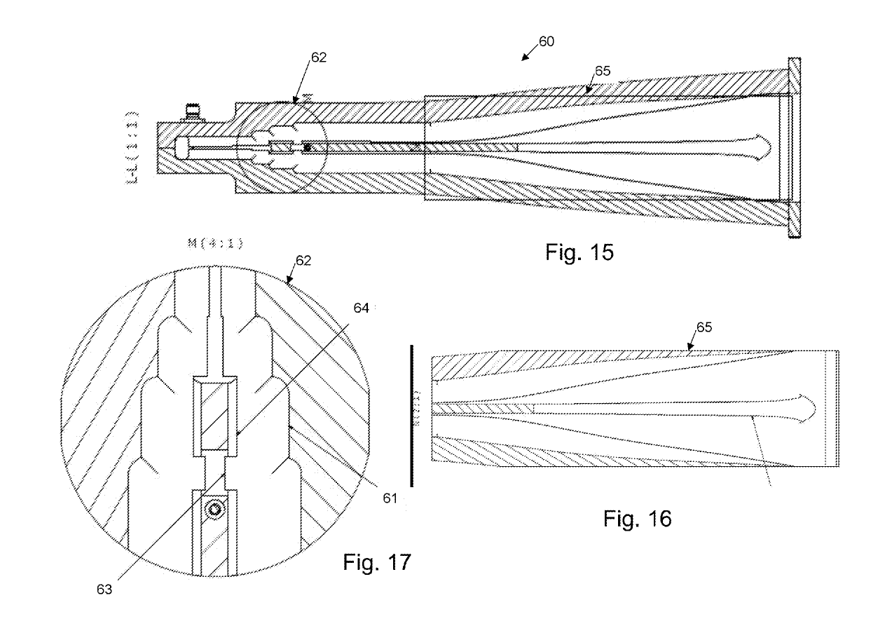

FIG. 11 illustrates a sectional view through the embodiment, with FIG. 14 illustrating an enlargement of the area 42 of FIG. 11 and FIG. 17 illustrating an enlargement of the area 62 of FIG. 15. In the orthogonal direction, the separation of the widely spaced ridges is reduced 63. This section 63 continues for approximately one quarter wavelength at the upper frequency of operation. This section is then followed by the coming together of the closely spaced ridges to form a short circuit 53 (FIG. 14) and an increase in the separation of the widely spaced ridges 64 (FIG. 17). In addition the outer wall of the quad-ridged waveguide is reduced in width in one plane 61 such that the polarisation in the quad-ridged waveguide with its electric field in the plane of the closely spaced ridges is “cut-off” at all frequencies of operation of the OMT.

In the other direction the coaxial waveguide to quad-ridged waveguide junction is followed by a transition to a quad ridge waveguide which is symmetric about 90 degree rotations and only allows the propagation of two anti-symmetric and one symmetric mode within the band of operation of the device.

This is followed by a smooth transition to square or circular waveguide (section 3). A key feature of this transition is the widening of the ridges towards the opening of the square or circular waveguide (e.g. 10, 11 of FIG. 2) which enables a reduction in the production of the TE31 mode in circular waveguide and its equivalent in square waveguide. This leads to a purer TE11 mode at the aperture and reduces asymmetry between the radiation pattern in the X and Y planes of any resulting feed system.

Section 1 constitutes a coaxial to double ridged waveguide transition. The second linear polarisation enters a section of double ridged waveguide in a similar manner to the first. A junction is formed between a double ridged waveguide and a coaxial waveguide by terminating the coaxial outer conductor at one ridge and either directly or capacitively connecting the inner conductor to the other ridge. The double ridged waveguide section is chosen such that it is single-moded over the frequency range of operation and has an impedance close to that of the coaxial port.

The coaxial to double ridged transition is terminated in one direction by a structure approximating an open circuit and in the other direction by a transition to a higher impedance double ridged waveguide which interfaces with section 2, described previously.

The structure approximating an open circuit in this case is formed by a short section of reduced height double ridged waveguide approximately a quarter wavelength long at the highest frequency of interest followed by a short circuit wall.

The propagating electromagnetic field generated by this section passes through section 2 and is transitioned to circular or square waveguide in a similar manner to the orthogonal polarisation generated in section 2.

Returning to FIG. 17, the preferred embodiment further include a series of tabs or vanes 67 which act to suppress back reflections from the coaxial source emitter. The tabs were found to improve the transmission characteristics of the antenna device.

### Interpretation

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. An orthogonal mode transducer including:
an elongated waveguide conduit for projecting orthogonal polarisation transmissions, the conduit having a proximal emission source end and a distal mouth end having an aperture for signal transmission;
said elongated conduit including a first pair of diametrically opposed axial ridges, and a second pair of diametrically opposed axial ridges, with the first and second pairs being substantially orthogonal to one another, and
the first pair of diametrically opposed axial ridges having an asymmetric narrowing of the gap between the ridges towards the proximal emission source relative to the second pair of diametrically opposed axial ridges.

2. An orthogonal mode transducer as claimed in claim 1 wherein at least one of said axial ridges increases in circumferential thickness towards the distal end of the conduit.

3. An orthogonal mode transducer as claimed in claim 1 wherein said asymmetric narrowing is provisioned substantially at the proximal emission source end only with the gap between the first pair of ridges and the gap between the second pair of ridges being substantially the same at the distal mouth end of said conduit.

4. An orthogonal mode transducer as claimed in claim 1 wherein said asymmetric narrowing occurs by a series of axial steps along said conduit.

5. An orthogonal mode transducer as claimed in claim 1, wherein said proximal emission source end includes at least one conductive emission source; said conductive emission source including a capacitive device profiled to match the internal inductance of the emission source over at least a portion of the operational bandwidth of the orthogonal mode transducer.

6. An orthogonal mode transducer as claimed in claim 5 wherein said capacitive device includes a section of low impedance coaxial conductive line.

7. An orthogonal mode transducer as claimed in claim 6 wherein said capacitive device includes a shunt capacitance between the inner and outer conductor of the coaxial conductive line.

8. An orthogonal mode transducer, including:
an elongated waveguide conduit for projecting orthogonal polarisation transmissions, the conduit having a proximal emission source end and a distal mouth end having an aperture for signal transmission; and
a series of axial ridges along the internal surface of said conduit, said axial ridges increasing in circumferential thickness towards the distal end of the conduit.

9. An orthogonal mode transducer as claimed in claim 8 wherein said series of axial ridges are arranged symmetrically around the conduit.

10. An orthogonal mode transducer as claimed in claim 8 wherein the number of axial ridges is four and said ridges are aligned with orthogonal linear polarisation transmissions along said conduit.

11. An orthogonal mode transducer as claimed in claim 8 wherein the radial thickness of said ridges decreases towards the distal end of said conduit.

12. An orthogonal mode transducer as claimed in claim 8 wherein at the distal end of said conduit, said ridges are flared and the radial thickness of said ridges approaches zero.

13. A method of suppressing spurious modes in an orthogonal mode transducer having an elongated waveguide conduit for projecting orthogonal polarisation transmissions, the conduit having a proximal emission source end and a distal mouth end having an aperture for signal transmission; the method including the steps of:
forming a series of axial ridges along the internal surface of said conduit, said axial ridges increasing in circumferential thickness towards the distal end of the conduit.

14. An orthogonal mode transducer including:
a waveguide conduit for projecting orthogonal polarisation transmissions, the conduit having a proximal emission source end and a distal mouth end having an aperture for signal transmission; and
said proximal emission source end including at least one conductive emission source; said conductive emission source including a capacitive device profiled to match the internal inductance of the emission source over at least a portion of the operational bandwidth of the orthogonal mode transducer.

15. An orthogonal mode transducer as claimed in claim 14 wherein said capacitive device includes a section of low impedance coaxial conductive line.

16. An orthogonal mode transducer as claimed in claim 14 wherein said capacitive device includes a shunt capacitance between the inner and outer conductor of the coaxial conductive line.

17. A method of improving the operational characteristics of an orthogonal mode transducer having a waveguide conduit for projecting orthogonal polarisation transmissions, the conduit having a proximal emission source end and a distal mouth end having an aperture for signal transmission, the method including the step of:
providing a capacitive device at said proximal emission source end profiled to match internal inductance of the emission source over at least a portion of the operational bandwidth of the orthogonal mode transducer.

18. An orthogonal mode transducer including:
an elongated waveguide conduit for projecting orthogonal polarisation transmissions, the conduit having a proximal emission source end and a distal mouth end having an aperture for signal transmission; and
said elongated conduit being narrowed towards said proximal emission source end in a radially asymmetric manner.

19. An orthogonal mode transducer as claimed in claim 18 wherein said narrowing occurs via a series of axial steps along said conduit.

20. An orthogonal mode transducer as claimed in claim 18 wherein said conduit also includes a series of axial ridges along the internal surface of said conduit, said axial ridges increasing in circumferential thickness towards the distal end of the conduit.

21. An orthogonal mode transducer including:
an elongated waveguide conduit for projecting orthogonal polarisation transmissions, the conduit having a proximal emission source end and a distal mouth end having an aperture for signal transmission;
said elongated conduit including a number of mode suppression vanes between and the proximal end and a coaxial transmitter for the suppression of spurious signals emitted from the coaxial transmitter.

22. An orthogonal mode transducer including:
an elongated waveguide conduit for projecting orthogonal polarisation transmissions, the conduit having a proximal emission source end and a distal mouth end having an aperture for signal transmission; and
said elongated conduit including a series of paired opposed ridges being narrowed towards said proximal emission source end in a radially asymmetric manner.

23. An orthogonal mode transducer as claimed in claim 22 wherein said narrowing occurs via a series of axial steps along said conduit.

24. An orthogonal mode transducer as claimed in claim 22 wherein said conduit also includes a series of axial ridges along the internal surface of said conduit, said axial ridges increasing in circumferential thickness towards the distal end of the conduit.

25. An orthogonal mode transducer as claimed in claim 22 wherein said radial asymmetry is provisioned substantially in the proximal emission source end only with the distal end being substantially radially symmetric.
